(19) United States
(12) Patent Application Publication
(10) Pub. No.: US 2011/0316293 A1
(43) Pub. Date: Dec. 29, 2011

(54) Rotary latch lock with belt drive

(75) Inventors: Thomas Lüschper, Essen (DE); Thorsten Janssen, Velbert (DE); Gerhard Mosch, Duisburg (DE); Bernd Gellhaus, Bochum (DE)

(73) Assignee: WITTE AUTOMOTIVE GMBH, Velbert (DE)

(21) Appl. No.: 13/166,678

(22) Filed: Jun. 22, 2011

(30) Foreign Application Priority Data
Jun. 23, 2010 (DE) 10 2010 017 537.4
Mar. 18, 2011 (DE) 10 2011 001 391.1

(51) Int. Cl. E05C 3/12; B65H 18/28

(52) U.S. Cl. 292/195; 242/160.4

(57) ABSTRACT

A lock with a rotary latch and with a pawl, wherein the pawl can be moved from a blocking position, in which it holds the rotary latch in a closed position, into a release position, in which it allows the rotary latch to rotate into an open position, by the winding of a traction element onto a winding body. A flexible belt, which is wound in spiral fashion around the winding body, can be used as the traction element.

### CROSS-REFERENCE TO RELATED APPLICATIONS

The present application claims priority of DE 10 2010 017 537.4, filed Jun. 23, 2010, and DE 10 2011 001 391.1, filed Mar. 18, 2011, the priority of these applications is hereby claimed and these applications are incorporated herein by reference.

### BACKGROUND OF THE INVENTION

The invention pertains to a lock with a rotary latch and with a pawl, wherein the pawl can be shifted from a blocking position, in which it holds the rotary latch in a closed position, into a release position, in which it allows the rotary latch to rotate into an open position, by the winding of a traction element onto a winding body.

A lock of this type is previously known from DE 10 2005 052 665 A1. The rotary latch lock described there has a lock base plate, which comprises a catch slot for a locking bar. A rotary latch comprising catch jaws for the locking bar is supported on one side of the catch slot; this latch can be shifted against the restoring force of a rotary latch spring into a closed position, in which the locking bar caught in the rotary latch jaws is held captured. The lock base plate supports a pawl, a latching stage of which, when in a blocking position, lies in front of a latching shoulder of the rotary latch and thus prevents the rotary latch from rotating from its closed position into its open position. A traction cable acts on an actuating arm of the pawl; the cable can be wound up onto a winding body formed by a motor shaft to shift the pawl from its blocking position into its release position, which allows the rotary latch to pivot from its closed position into its open position.

### SUMMARY OF THE INVENTION

The invention is based on improving such a lock.

The goal is accomplished by the invention, wherein it is provided first and essentially that the traction element is a flexible belt. This belt is wound in spiral fashion around the winding body. Individual turns of the belt can thus rest on top of each other, which means that, as the belt is being wound up, the effective diameter of the coil increases. The belt can be formed as a one-piece unit with the winding body. For this purpose, the belt and the winding body can be injection-molded out of a suitable plastic. The winding body can have an eccentric shape. In this case, the winding body preferably has the shape of an eccentric cam, where surface sections on which the belt can rest are different distances away from the rotational axis of the winding body depending on their point on the circumference. The length of the belt is calculated in such a way that, in the actuation phase, during which the greatest forces must be applied to the pawl, the working point of the belt is the minimum distance away from the takeoff shaft, so that the electric motor preferably used to drive the winding body can exert the maximum torque on the belt during this actuation phase. The belt is elastic preferably in the sense that it is able only to bend, so that it can be wound in spiral fashion around the winding body but is stiff in the direction transverse to that. Because the belt is wound in spiral fashion around the winding body, the force which can be transmitted by the belt to the pawl changes over the course of the movement of the pawl from its blocking position to its release position. The opening drive exerts its greatest tractive force during the phase in which the latching stage is disengaged from the latching shoulder. In a preferred variant, the belt acts on a transmission lever, which, like the rotary latch and the pawl, is supported so that it can rotate around an axis fixed to the base plate. The transmission lever can comprise two arms. The free end of the traction belt acts on one of these two arms, namely, the drive arm, the free end of the belt preferably being designed as a coupling pin, which rests in a coupling opening, such as an opening with a claw-like shape, in the drive arm. A takeoff arm, preferably projecting at a right angle to the drive arm, acts on an actuating arm. This actuating arm is supported rotatably around the same axis as that around which the pawl rotates. The pawl can comprise a driver, on which a stop shoulder of the actuating arm acts to carry the pawl along from the blocking position into the release position, preferably after traveling a certain free distance. It has been found to be favorable with respect to the physics of levers for the takeoff arm of the transmission lever to act on the outermost end of the actuating arm, which, in one variant of the invention, can also be rigidly connected to the pawl. To reduce the opening force, the latching stage and the latching shoulder engage with each other at a positive angle. In another variant, the lock has only one latch, such as a latch with a negative angle. To prevent vibrations from causing the pawl, when in the blocking position, from becoming unlatched by itself, the pawl is held in the blocking position by a blocking element. This blocking element is designed as a blocking cam, which, when in a blocking position, lies in front of a blocking shoulder of the pawl. The blocking cam is preferably a component of the transmission lever and, in a first actuation phase, is pivoted out of its blocking position upon rotation of the winding body. Only then does the takeoff arm of the transmission lever engage with the working end of the actuating arm to shift the actuating arm against the restoring force of a spring over a certain free travel distance until its stop shoulder arrives at the driver of the pawl and shifts the pawl into the release position. In a preferred embodiment, a storage hook is formed on the actuating arm; during the movement into the release position, this hook travels over a storage web, which is assigned to the rotary latch and on the outside wall of which the storage hook rests when the rotary latch moves from its closed position to its open position. This prevents the pawl from moving back into the blocking position, after the belt has been turned back, for example, before the rotary latch has opened completely. The main latching stage or a prelatching stage also assigned to the pawl is thus prevented from arriving in a latching position relative to the latching shoulder of the rotary latch during the course of the opening movement of the rotary latch.

The pawl is supported rotatably around a rotational axis permanently attached to the housing and has a core made of steel, which forms a prelatching stage and a main latching stage. When the rotary latch moves from its open position to its closed position, a rotary latch spring is put under tension. During the course of the rotational movement, a radially projecting section of the latching shoulder of the rotary latch slides along a ramp-like flank of the pawl, which ends in a prelatching stage formed by the pawl. Once past the prelatching stage, the pawl can pivot into the prelatching position under the action of its rotary latch spring, wherein the prelatching stage comes to rest under the latching shoulder, so that the rotary latch cannot be turned back into the open position. The rotary latch, however, can be turned farther away from the prelatching position toward the closed position, wherein, here again, a radially projecting section of the latching shoulder slides along a control flank of the pawl until the main latching stage of the rotary latch passes under the latching shoulder. Whereas the prelatching stage and the other essential surface sections of the pawl are jacketed with plastic, the main latching stage does not have a jacket of plastic. The steel surface of the main latching stage rests on a steel surface of the latching shoulder of the rotary latch, which otherwise can also be jacketed with plastic. A spring web formed by the plastic jacketing of the pawl rests on the radially outermost section of the latching shoulder to prevent rattling.

The invention also pertains to a winding body. The winding body can be used quite generally in locks and actuating elements and has the previously described property. It is an injection-molded part of plastic with a winding body, the horizontal section of which extends along an eccentric line around an axis. At the axis, an opening can be provided, which comprises a noncircular cross section, and into which a drive shaft of a drive motor can be inserted. The traction element, which is designed as a flat belt, can be wound around the winding body in the form of spiral turns. At its free end, the belt carries coupling pins, which can engage in coupling openings in an actuating element such as a drive arm. The production of the winding body together with the belt is carried out by the injection-molding process, wherein the belt is preformed into a spiral. In the relaxed state, the flexible belt then extends in such a way that the individual turns of the belt are separated from each other by an air gap. As a result, the motion transmission means consisting of the winding body and the belt can be fabricated very easily.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE DRAWING

In the drawing:

FIG. 1 shows a top view of the lock of an exemplary embodiment of the lock in the closed position;

FIG. 2 shows a perspective, partially exploded view of the rotary latch 1, the pawl 2, the actuating arm 3, and the opening gear train 4, 5, 6, 18 in the closed position;

FIG. 3 shows a diagram according to FIG. 1, wherein the transmission lever 6 has been shifted by traction of the belt 4 until it has reached an action position on the actuating arm 3 and has pushed the actuating arm 3 until it has arrived in a driving position on the pawl 2;

FIG. 4 shows the functional position according to FIG. 3 looking in the direction of the arrow IV in FIG. 3;

FIG. 5 shows a diagram of a state subsequent to that of FIG. 3, wherein the actuating arm 3 of the transmission lever 6 has moved the pawl into its release position, wherein a storage hook 16 has passed over a storage web 17 but the rotary latch 1 has still not pivoted into the open position;

FIG. 6 shows a diagram of a state subsequent to that of FIG. 5, wherein the rotary latch has been pivoted into its open position and the pawl is still in its release position;

FIG. 7 shows the functional position according to FIG. 6 looking in the direction of the arrow VII of FIG. 6;

FIG. 8 shows a diagram of a state subsequent to that of FIG. 6, wherein the belt 4 has been brought into a releasing position;

FIG. 9 shows only the rotary latch 1 in its open position and the pawl 2 in the release position;

FIG. 10 shows a diagram according to FIG. 8, after the rotary latch 1 has been pivoted from its open position into a prelatching position, in which a prelatching stage 10 grips the latching stage 8 from underneath;

FIG. 11 shows only the rotary latch 1 and the pawl 2 in the prelatching position;

FIG. 12 shows only the rotary latch and the pawl 2 in the main latching position;

FIG. 13 shows a cross section through the pawl along cross-sectional line XIII-XIII in FIG. 12; and

FIG. 14 shows a cross section through the pawl along cross-sectional line XIV-XIV in FIG. 13.

### DETAILED DESCRIPTION OF THE INVENTION

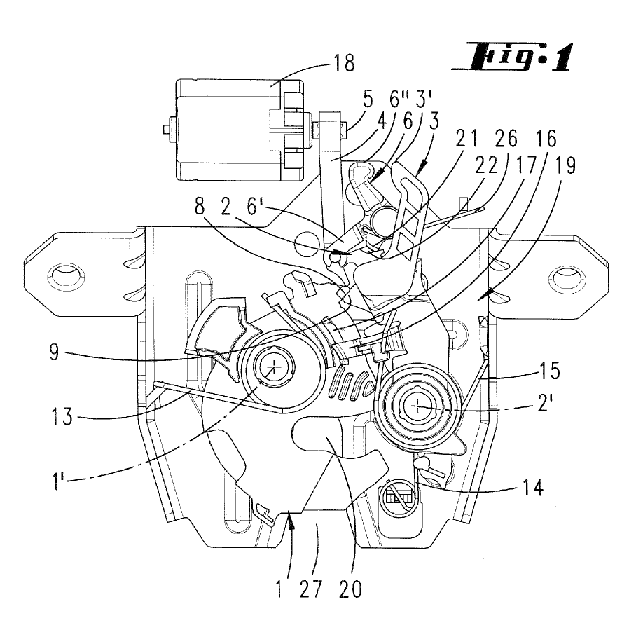

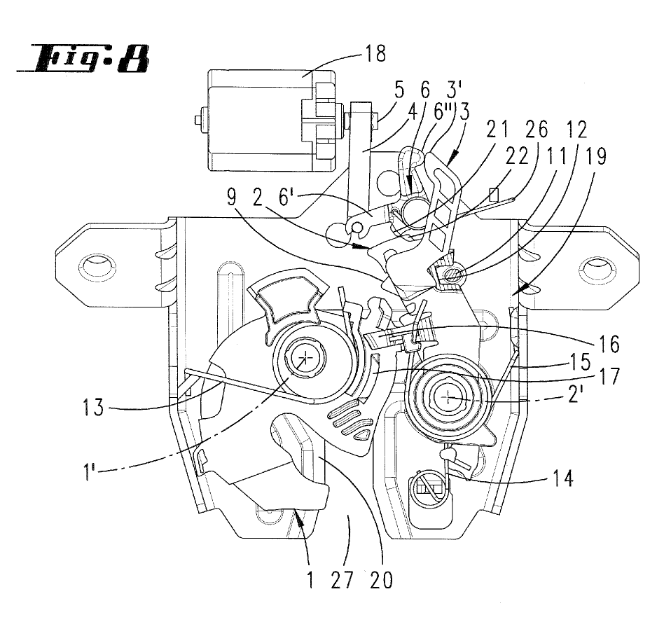

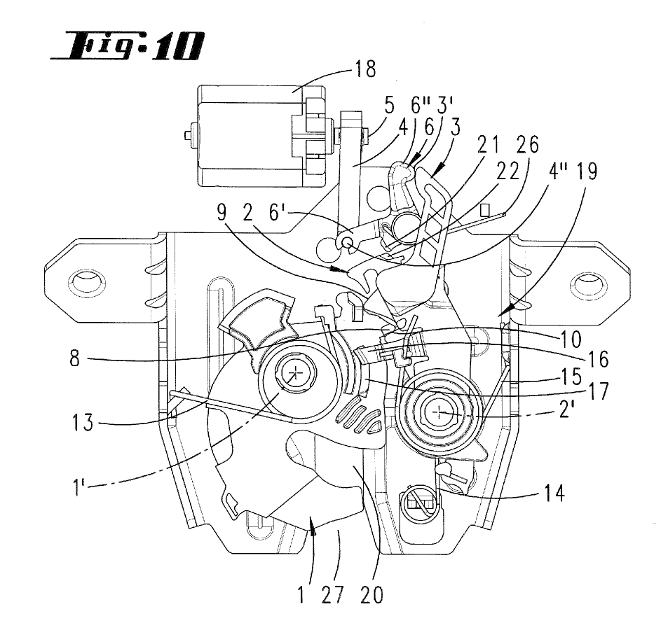

The lock shown in the drawings can be used in a motor vehicle as a rear hatch lock or as a door lock. It works together with a locking bar (not shown), which, when the lock is being closed with the rotary latch in the opened position (FIG. 8), is caught in a capture slot 27 of the base plate 19 and then enters the open rotary latch jaws 20 of the rotary latch 1. The locking bar (not shown) then acts on a flank of the rotary latch jaws 20 and pivots the rotary latch 1 against the restoring force of the rotary latch spring 13 past the prelatching position shown in FIG. 10, in which a prelatching stage 10 of a pawl 2 lies under a latching shoulder 8 of the rotary latch 1, until the rotary latch reaches the closed position shown in FIG. 1, in which the main latching stage 9 of the pawl 2 lies under the latching shoulder 8. If the lock is in the door of a motor vehicle, then the opposing part of the lock, which can be the previously mentioned locking bar or a U-bracket, is mounted on the frame of the vehicle body. If the lock is used on a trunk lid or on a hatch cover/side door, then the lock can be on the vehicle body or on the hatch cover/door. It then also acts together with a locking bar or with a U-bracket, which, when the hatch cover/door is being closed, enters the capture slot 27 and then the rotary latch jaws 20.

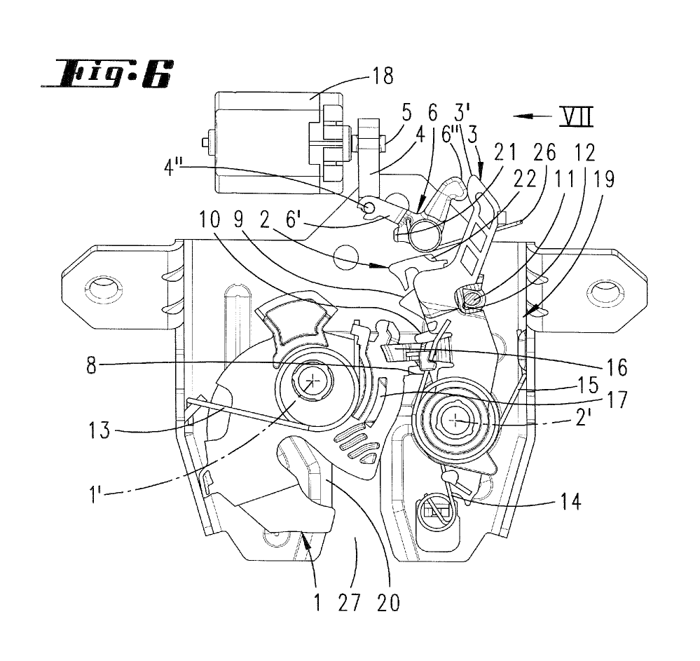

The rotary latch 1 is supported so that it can rotate around a rotary latch axis 1 on the base plate 19. The rotary latch spring 13 is designed as a torsion spring. A first leg of the spring is supported against the base plate 19, whereas the second leg is supported against the rotary latch 1, so that torque can be exerted on the rotary latch 1 in the direction toward the open position shown in FIG. 6.

The pawl 2 is supported on the base plate 19 so that it can pivot around a pawl axis 2′; the pawl has a first arm, which forms the main latching stage 9 and the prelatching stage 10. A second arm of the pawl 2 is actuated by a pawl spring 14. In the exemplary embodiment, the pawl spring 14 is designed as a torsion spring, which actuates the pawl 2 in the direction toward its blocking position shown in FIG. 1. The two arms of the pawl 2 thus consist of a blocking arm, which provides the latching stages 9, 10, and a working arm, more-or-less directly opposite the blocking arm, upon which the pawl spring 14 acts.

An actuating arm 3, which is made of plastic, is also supported rotatably around the rotational axis 2′ of the pawl. For this purpose, the actuating arm 3 is provided with a bearing eye 3″. The radially outermost end of the actuating arm 3 forms a working end 3′, on which a takeoff arm 6″ of a transmission lever 6 acts.

The pawl 2 forms a driver 11, projecting from the pawl's plane of rotation. This driver 11, designed as a stud, lies in a niche in the actuating arm 3, the rear wall of which forms a stop shoulder 12, which, in the closed position shown in FIG. 1, is a certain free travel distance away from the driver 11.

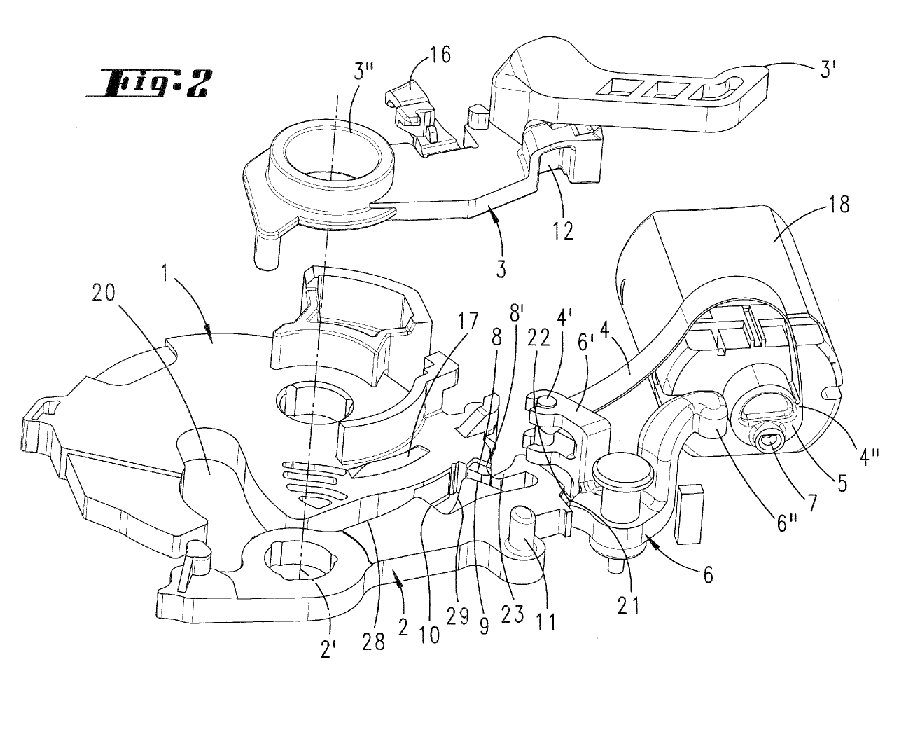

In the closed position shown in FIGS. 1 and 2, the takeoff arm 6″ of the transmission lever 6 is a certain distance away from the working end 3″. The transmission lever is supported rotatably on the base plate 19 and forms a drive arm 6′, which projects more or less at a right angle to the takeoff arm 6″. The end of the drive arm 6′ is designed as claw-like coupling openings. The end of the drive arm 6′ consists of two arm sections, extending parallel to each other in a fork-like manner. The end of a coupling pin, which is permanently connected to the fixed end 4″ of a belt 4, passes through the two coupling claws formed by each arm section.

The belt 4 consists of plastic and forms a one-piece molded unit together with the coupling pin and a winding body 5. The belt 4 is connected tangentially to the winding body 5 at a connecting point 4″.

The winding body 5 preferably has an eccentric shape. It can also be round, however, with a rotational axis in the center. It is seated on a drive axis 7, which can be turned by an electric motor 18. The essentially circular circumferential contour of the winding body 5 is eccentric to its rotational axis 7.

A torsion spring 15, which is designed as an actuating leg spring, one leg of which is supported against the base plate 19 while the other is supported against the actuating arm 3, is wound around the pawl support axis 2′ to actuate the actuating arm 3 in the direction toward the blocking position of the pawl 2. In the closed position shown in FIGS. 1 and 2, a storage hook 16 formed on the actuating arm 3 extends over a storage web 17, which forms an arc centered on the bearing axis 1′ of the rotary latch 1. On the side facing the bearing axis 1′, the storage web 17 has a ramp-like bevel, along which the storage hook 16 can slide when the actuating arm 3 is shifted in the direction toward the release position of the pawl 2. The side of the storage web 17 facing away from the bearing axis 1′ is vertical, so that the storage hook 16 can support itself against it, which prevents the actuating arm from moving toward the blocking position.

The rotary latch 1 and the pawl 2 are plastic-jacketed steel bodies. The pawl 2 has a steel core 24, which has a stud which forms the driver 11. It can be seen in FIG. 14 that the pawl 2, which is made as a stamped part, forms both a prelatching stage 10 and a main latching stage 9. Whereas the prelatching stage 10 is covered by the pawl jacketing 25, the steel core 24 of the pawl 2 is exposed in the area of the main latching stage 9. Behind the main latching stage 9, the pawl jacketing 25 forms a spring web 23, which rests against the free end 8′ of the latching shoulder 8 of the rotary latch 1 to avoid rattling. The rotary latch 1 is provided with a plastic jacket except for the latching shoulder 8.

Both the rotary latch 1 and the pawl 2 have a base body of steel, which can be a stamped part. Both base bodies are overmolded with plastic jackets 25. In the case of the pawl 2, the driver stud 11 is also overmolded with plastic. The pawl 2 and the rotary latch 1 lie in a common plane of rotation. Also located in this plane are the two latching sites 8, 9 and 9, 10.

The lock functions in the following way:

In the closed position shown in FIGS. 1 and 2, the rotary latch 1 is held by the main latching stage 9 of the pawl 2. This stage lies under the latching shoulder 8 of the rotary latch 1. The latching shoulder 8 has a positive angle, so that, when torque acts on the rotary latch 1 in the opening direction, a certain torque is exerted on the pawl 2 in the direction toward its release position. To prevent this torque from pivoting the pawl 2 into its release position, the blocking cam 21 of the transmission lever 6 lies in a niche in the pawl 2 in the closed position, this niche forming a blocking shoulder 22. As a result, the pawl 2 is held positively in its blocking position.

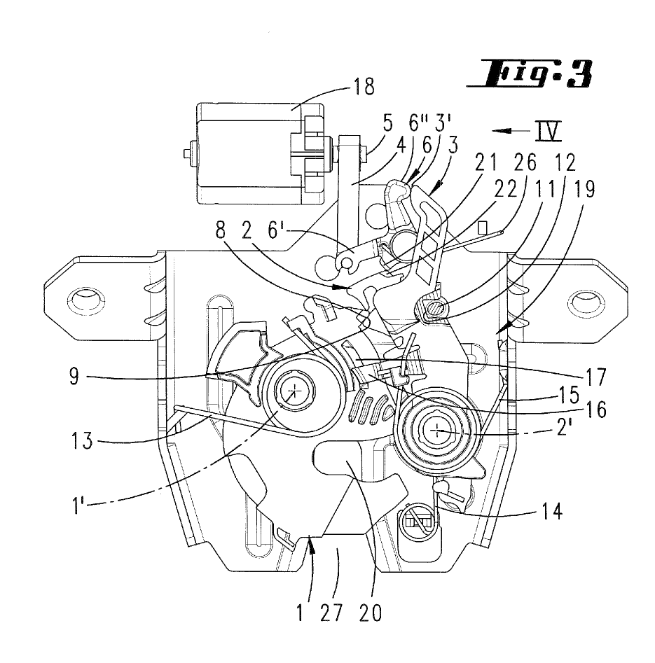

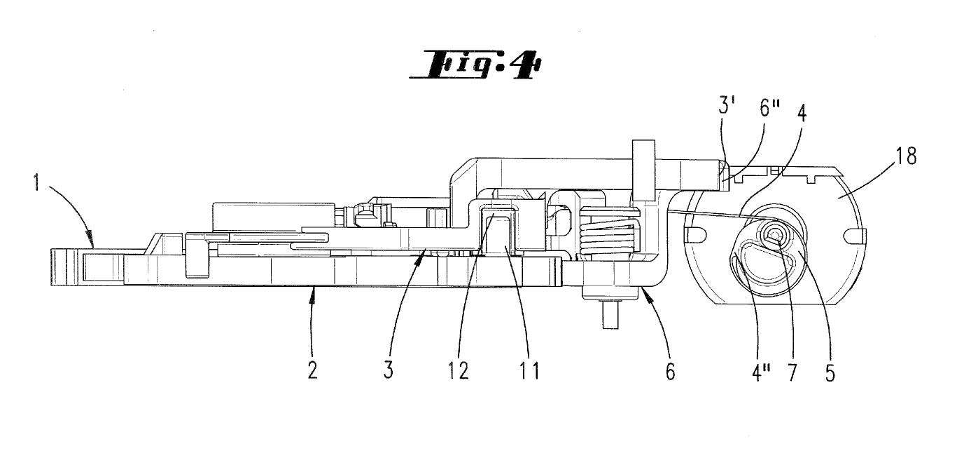

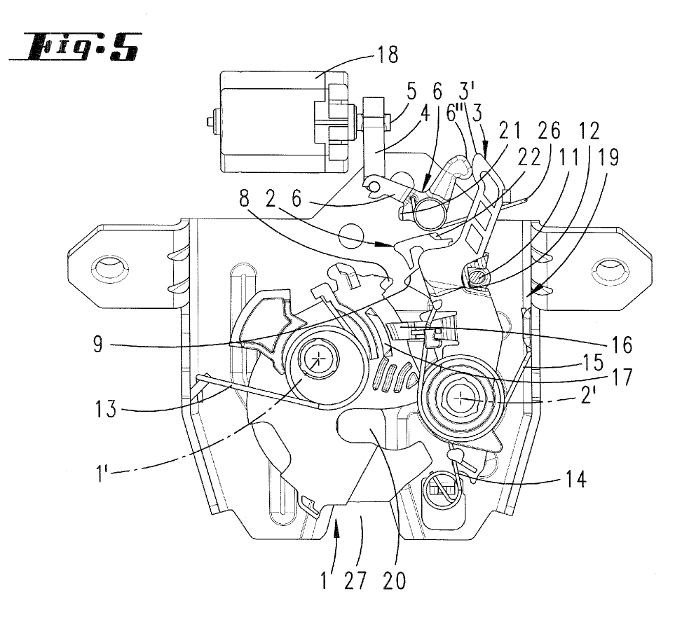

To open the lock, the electric motor 18 is turned on. The belt 4, which, in the closed position, forms a relaxed arc, is wound up onto the winding body 5 until it is tensioned. The drive end 4′ of the belt 4 now exerts torque on the transmission lever 6. This lever pivots until the takeoff arm 6″, which is a certain distance away from the working end 3 when the closed position is present, contacts the working end 3′. As the rotation of the transmission lever continues, the actuating arm 3 is pivoted further by the action of the takeoff arm 6″ on the working end 3′ until the position shown in FIG. 3 is reached, wherein the free travel distance between the stop shoulder 12 and the driver 11 is used up. In the position of the lock shown in FIG. 3, the winding body 5 has reached the rotational position shown in FIG. 4, in which the “arm” of the eccentric winding body 5 acting on the belt 4 is at a minimum, which means that the electric motor is now exerting maximum tractive force on the belt 4. As a result of this tractive force, the pawl 2 is carried along by the actuating arm 3, wherein the position of the main latching stage 9 relative to the latching shoulder 8 shifts until the release position shown in FIG. 5 is reached, in which the rotary latch 1 is free to rotate into its open position under the force of the tensioned rotary latch spring 13. The length of the belt 4 and the eccentric arrangement of the rotational axis 7 relative to the eccentric circumferential surface of the winding body 5 are selected so that the belt exerts its greatest tractive force at the point when the latching engagement between the latching shoulder 8 and the main latching stage 9 is overcome.

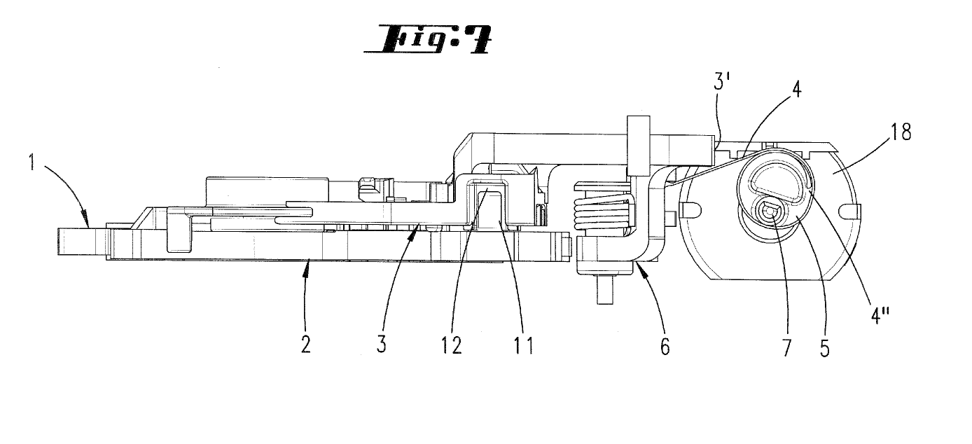

As a result of the pivoting movement of the actuating arm 3, the storage hook 16 has slid over the storage web 17. Now, even if, in the release position of the pawl 2 shown in FIG. 5, the electric motor 18 relaxes the belt 4, the actuating arm 3 and thus also the pawl 2 cannot pivot backward. Proceeding from the position shown in FIG. 5, the rotary latch 1 can now pivot into the open position shown in FIG. 6. FIG. 7 shows the rotational position of the winding body 5 in the fully pivoted position of the actuating arm 3 and the pawl 2.

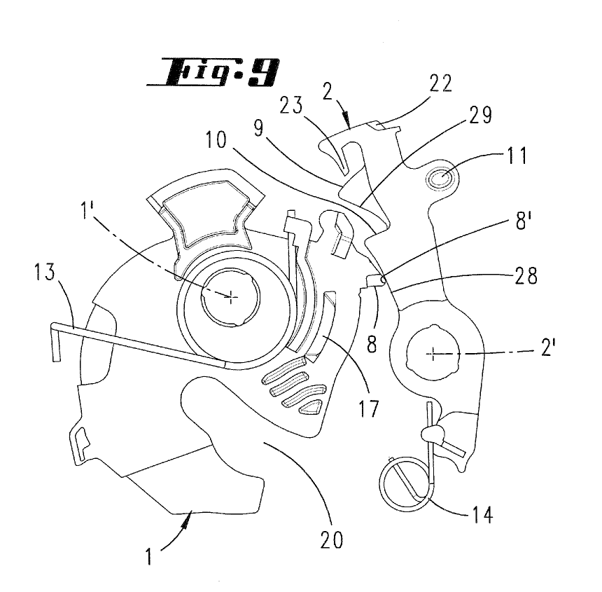

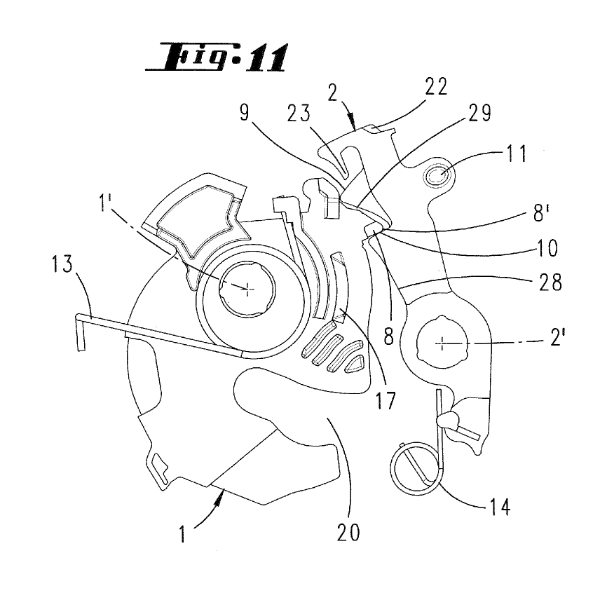

Once the open position shown in FIGS. 6 and 7 is reached, the motor 18 is operated in the opposite direction, so that the belt 4 relaxes. As a result of this belt relaxation, the actuating arm 3 and the pawl 2 pivot backward until the ramp-like flank 28 of the pawl 2 strikes the radially outermost 8′ of the latching shoulder 8. This section forms a slide section 8′, which, upon rotation of the rotary latch 1 in the direction toward its closed position, slides along the ramp-like flank 28. Thus the pawl 2, proceeding from the open position of the rotary latch 1 shown in FIG. 9, pivots slightly in the direction toward its release position, until the slide section 8′ has passed beyond the ramp-like flank 28 and occupies the prelatching position shown in FIGS. 10 and 11, in which the pawl spring 14 has pushed the pawl 2 back again in the direction of its blocking position, wherein the prelatching stage 10 lies under the latching shoulder 8.

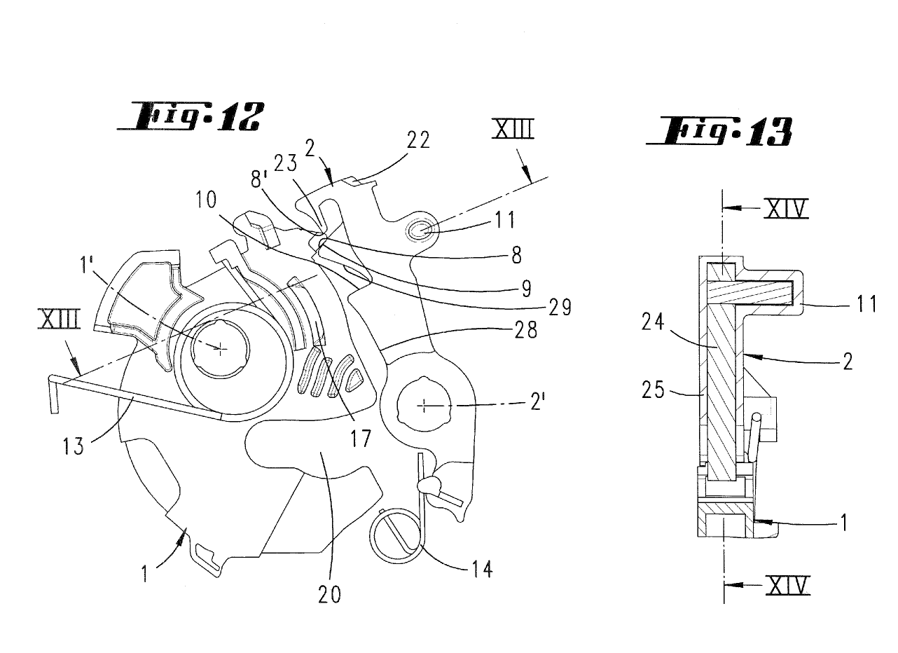

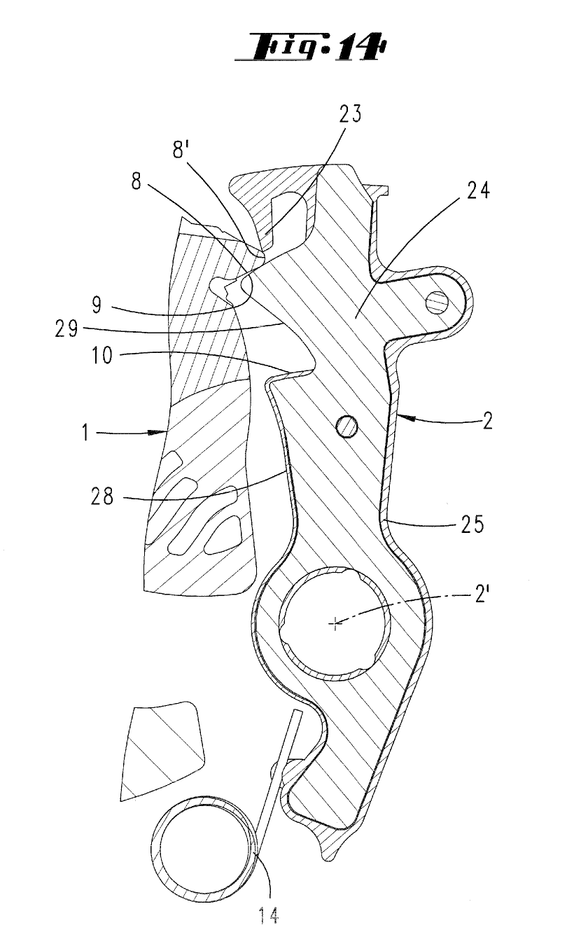

When, proceeding from the prelatching position shown in FIGS. 10 and 11, the rotary latch moves even farther toward its closed position, the slide section 8′ slides along another ramp-like flank 29 of the pawl 2 until the slide section 8′ has passed completely beyond this ramp-like flank 29 and the main latching stage 9 swings under the latching shoulder 8. This closed position, shown in FIG. 12, corresponds to the operating position according to FIG. 1.

It can be derived from FIG. 14 that the ramp-like flank 28, which contains by way of a rounded corner into the prelatching stage 10, as well as the prelatching stage 10, is jacketed with plastic. The ramp-like flank 29, which also continues by way of a rounded corner into the main latching stage 10, is not jacketed. It can also be seen in FIG. 14 that the spring web 23 is fabricated out of the same plastic material as the pawl jacketing 25. When the pawl 2 is in the blocking position, the spring web 23 acts on the outermost section 8′ of the latching shoulder 8. As a result of the force of the pawl spring 14 acting on the pawl 2, the spring web 23 lies under slight spring pretension against the rotary latch 1.

Both the rotary latch 1 and the pawl 2 are made simply from flat pieces of steel. All of the contours on the wide sides are formed by the associated jacketing of plastic. The only exception to this is the driver 11, which is formed by a cylindrical steel stud, which is force-fit into an opening in the pawl 2. The latching shoulder is integral with the material of the core of the rotary latch 1, and the two latching stages 9, 10 are integral with the material of the core of the pawl 2.

While specific embodiments of the invention have been shown and described in detail to illustrate the inventive principles, it will be understood that the invention may be embodied otherwise without departing from such principle.

We claim:

1. A lock, comprising: a rotary latch; a pawl; a winding body; and a traction element, wherein the pawl is shiftable from a blocking position, in which the pawl holds the rotary latch in a closed position, into a release position, in which the pawl allows the rotary latch to rotate into an open position, by winding of the traction element onto the winding body, wherein the traction element is a flexible belt that is wound in spiral fashion around the winding body.

2. The lock according to claim 1, wherein the belt is a one-piece unit with the winding body and is made of plastic.

3. The lock according to or especially according to claim 1, wherein the winding body has an eccentric shape.

4. The lock according to claim 1, wherein the traction element acts on a transmission lever that has takeoff arm that cooperates with an actuating arm that moves the pawl.

5. The lock according to claim 4, wherein the belt has a drive end that forms a coupling pin that lies in a coupling opening of a drive arm of the transmission lever.

6. The lock according to claim 5, wherein the coupling opening has a claw-shape.

7. The lock according to claim 4, wherein the takeoff arm of the transmission lever acts on an outermost end of the actuating arm, which in turn rotates around a rotational axis of the pawl.

8. The lock according to claim 4, wherein the transmission lever forms a blocking cam, which cam, when the pawl is in the blocking position, lies in front of a blocking shoulder of the pawl to prevent the pawl from moving into the release position.

9. The lock according to claim 4, wherein the actuating arm cooperates with the pawl by way of a stop shoulder, which acts on, and is a certain free travel distance away from, a driver on the pawl.

10. The lock according to claim 4, comprising a storage hook formed on the actuating arm, which hook cooperates with a storage web on the rotary latch to hold the pawl in the release position as the rotary latch rotates from the closed position into the open position.

11. The lock according to claim 1, wherein the pawl forms a main latching stage that cooperates with a latching shoulder of the rotary latch and a prelatching stage that cooperates with the latching shoulder.

12. A winding body with a traction element, wherein the winding body is of eccentric design and the traction element is a belt wound in spiral fashion around the winding body, the winding body being connected to the traction element in that they are formed as a one-piece unit out of the same material.

13. The winding body according to claim 12, wherein the winding body and the belt, which is preformed to assume a spiral shape, are produced as an injection-molded plastic part.
